(19) United States
(12) Patent Application Publication
(10) Pub. No.: US 2011/0260820 A1
(43) Pub. Date: Oct. 27, 2011

(54) BOBBIN AND TRANSFORMER HAVING SUCH BOBBIN

(75) Inventor: Kao-Tsai Liao, Taoyuan Hsien (TW)

(73) Assignee: DELTA ELECTRONICS, INC., Taoyuan Hsien (TW)

(21) Appl. No.: 13/091,223

(22) Filed: Apr. 21, 2011

(30) Foreign Application Priority Data
Apr. 23, 2010 (TW) 099112929

(51) Int. Cl. H01F 27/29

(52) U.S. Cl. 336/192

(57) ABSTRACT

A transformer includes at least one primary winding coil, at least one secondary winding coil, a bobbin and a magnetic core assembly. The bobbin includes a main body with at least one winding section, a first base disposed under the main body, and plural fastening pins disposed on the first base. The primary winding coil and the secondary winding coil are wound around the main body. Each of the plural fastening pins includes a clamping part for clamping an outlet part of the primary winding coil or the secondary winding coil on the first base. The magnetic core assembly is partially received within the bobbin.

### FIELD OF THE INVENTION

The present invention relates to a bobbin, and more particularly to a bobbin with fastening pins. The present invention also relates to a transformer having such a bobbin.

### BACKGROUND OF THE INVENTION

A transformer is an electronic component for adjusting various voltages required for various kinds of electric appliances.

Generally, a transformer includes a bobbin, a magnetic core assembly, a primary winding coil and a secondary winding coil. Each of the primary winding coil and the secondary winding coil is formed of a plurality of single-core wires or a multi-strand wire. In addition, the primary winding coil and the secondary winding coil are wound around the winding section of the bobbin. The primary winding coil and the secondary winding coil interact with the magnetic core assembly to achieve the purpose of voltage regulation. Furthermore, multiple pins are mounted on the bobbin. The outlet parts of the primary winding coil and the secondary winding coil are soldered on the pins. Moreover, the pins may be inserted corresponding conductive holes of a circuit board such that the transformer is fixed on the circuit board.

There are two common kinds of pins, i.e. a linear pin and an L-shaped pin. Recently, the transformer is designed to withstand large magnitude of current. For withstanding the large magnitude of current, the primary winding coil or the secondary winding coil has increased number of single-core wires (or multi-strand wire). After the outlet part of the primary winding coil or the secondary winding coil is soldered on the linear pin, the soldering point becomes very thick. As such, the soldering process is complicated, and the adjacent pins are readily suffered from a short-circuited problem because the solder bump is too large. Moreover, if the pin is too thin, the pin is readily suffered from deformation during the process of wining the outlet part around the pin, and thus misalignment between the pin and the conductive hole of the circuit board occurs. In addition, since the process of winding the outlet part of the single-core wires (or multi-strand wire) is complicated and the process of arranging the outlet part is not easy, the process of assembling the transformer is time-consuming and labor-intensive.

Although the L-shaped pin may solve some drawbacks of the linear pin, the use of the L-shaped pin also incurs some problems. For example, since the single-core wires (or multi-strand wire) of the outlet part are still bundled together and soldered on the downward part of the L-shaped pin, it is difficult to control the thickness of the downward part and it is difficult to control the conductive hole of the circuit board. After the downward part of the L-shaped pin is connected with the conductive hole of the circuit board, the solder may overflow or a cavity may be formed in the solder. Moreover, since the bobbin is made of plastic material, if the welding gun is in contact with the bobbin during the outlet part is soldered on the pin, the bobbin will be molten and the pin will be shifted.

### SUMMARY OF THE INVENTION

It is an object of the present invention to provide a bobbin having a fastening pin for clamping the outlet part of the winding coil in order to avoid the problems of causing short circuit, deformation, solder overflow or solder cavity, and pin shift.

Another object of the present invention provides a transformer, in which the pin deformation problem is avoided, the outlet part of the winding coil is well arranged, the wire-arranging process is time-saving, and the solderability of the pin is enhanced.

In accordance with an aspect of the present invention, there is provided a transformer. The transformer includes at least one primary winding coil, at least one secondary winding coil, a bobbin and a magnetic core assembly. The bobbin includes a main body with at least one winding section, a first base disposed under the main body, and plural fastening pins disposed on the first base. The primary winding coil and the secondary winding coil are wound around the main body. Each of the plural fastening pins includes a clamping part for clamping an outlet part of the primary winding coil or the secondary winding coil on the first base. The magnetic core assembly is partially received within the bobbin.

In accordance with another aspect of the present invention, there is provided a bobbin. The bobbin includes a main body with at least one winding section, a base disposed under the main body and at least one fastening pin disposed on the base. The winding coil is wound around the winding section. The fastening pin includes a clamping part for clamping an outlet part of the winding coil on the base.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic exploded view illustrating a transformer according to an embodiment of the present invention;

FIG. 2 is a schematic perspective view illustrating the bobbin of the transformer of FIG. 1;

FIG. 3A is a schematic perspective view illustrating the bobbin, in which the primary winding coil and the secondary winding coil are wound around the bobbin;

FIG. 3B is a schematic upside-down view of FIG. 3A;

FIG. 4A is a schematic perspective view illustrating an exemplary fastening pin according to the present invention;

FIG. 4B is a schematic stretched-out view illustrating the fastening pin of FIG. 4A; and

FIG. 5 is a schematic perspective view illustrating a portion of the bobbin of FIG. 3A, in which the outlet part of the winding coil clamped by the clamping part of the fastening pin.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

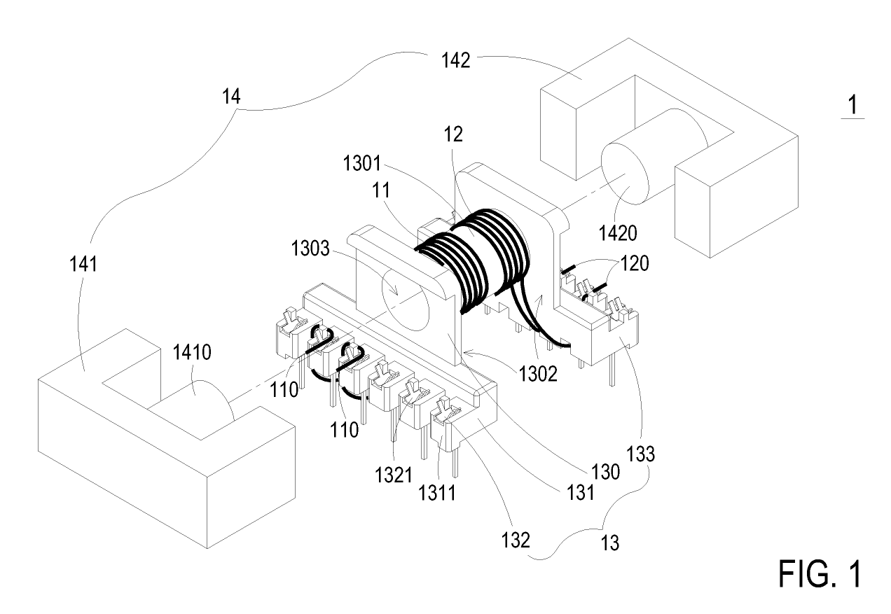

FIG. 1 is a schematic exploded view illustrating a transformer according to an embodiment of the present invention. As shown in FIG. 1, the transformer 1 includes a primary winding coil 11, a secondary winding coil 12, a bobbin 13 and a magnetic core assembly 14. The bobbin 13 includes a main body 130, a first base 131 and plural fastening pins 132. In this embodiment, each of the primary winding coil 11 and the secondary winding coil 12 is formed of plural single-core wires or a multi-strand wire. The primary winding coil 11 and the secondary winding coil 12 are wound around the winding section 1301 of the main body 130. In addition, the primary winding coil 11 and the secondary winding coil 12 are separated from each other by an insulating element (not shown). The first base 131 is disposed under the bottom 1302 of the main body 130 for supporting the plural fastening pins 132. Each fastening pin 132 has a clamping part 1321 for clamping an outlet part 110 of the primary winding coil 11 or an outlet part 120 of the secondary winding coil 12 on the first base 131. An example of the magnetic core assembly 14 includes but is not limited to an EE-type magnetic core assembly. The magnetic core assembly 14 is at least partially received within the bobbin 13.

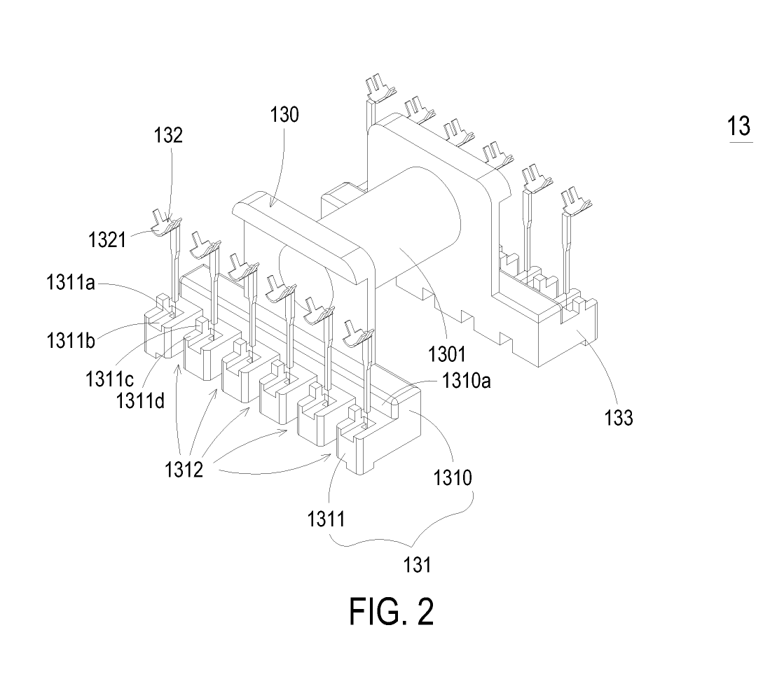

FIG. 2 is a schematic perspective view illustrating the bobbin of the transformer of FIG. 1. As shown in FIGS. 1 and 2, the first base 131 of the bobbin 13 includes a connecting part 1310 and plural extension parts 1311. The connecting part 1310 is connected with the main body 130. The plural extension parts 1311 are discretely arranged on a first surface 1310a of the connecting part 1310 at regular intervals to define plural wire-arranging notches 1312. In other words, a wire-arranging notch 1312 is defined between every two adjacent extension parts 1311. Each extension part 1311 includes a perforation 1311a, a receiving recess 1311b and a bulge 1311c. The receiving recess 1311b is formed in an upper surface 1311d of the extension part 1311 for receiving the clamping part 1321 of the fastening pin 132. The bulge 1311c is arranged beside the receiving recess 1311b for guiding the outlet part 110 of the primary winding coil 11 or the outlet part 120 of the secondary winding coil 12. Moreover, the bobbin 13 is made of thermosetting material or thermoplastic material. It is preferred that the bobbin 13 is made of thermosetting material.

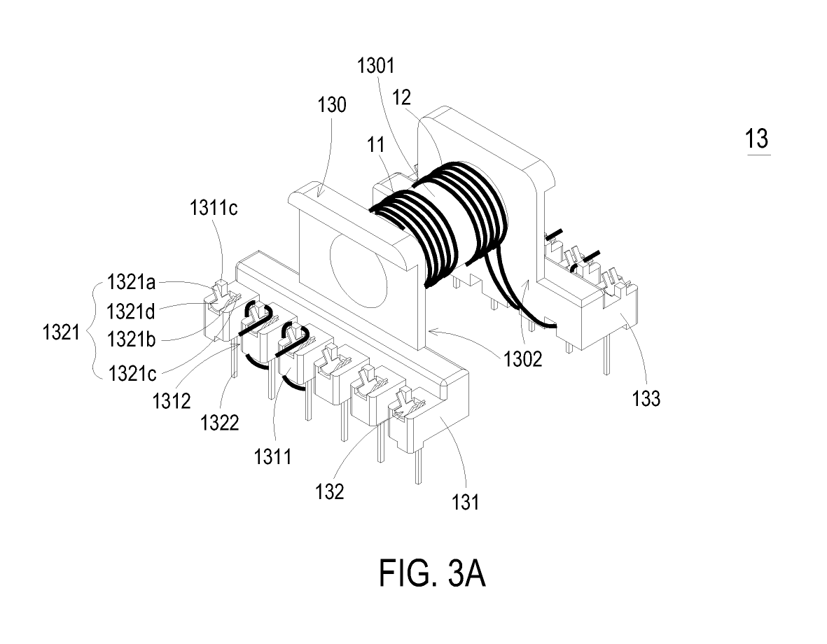

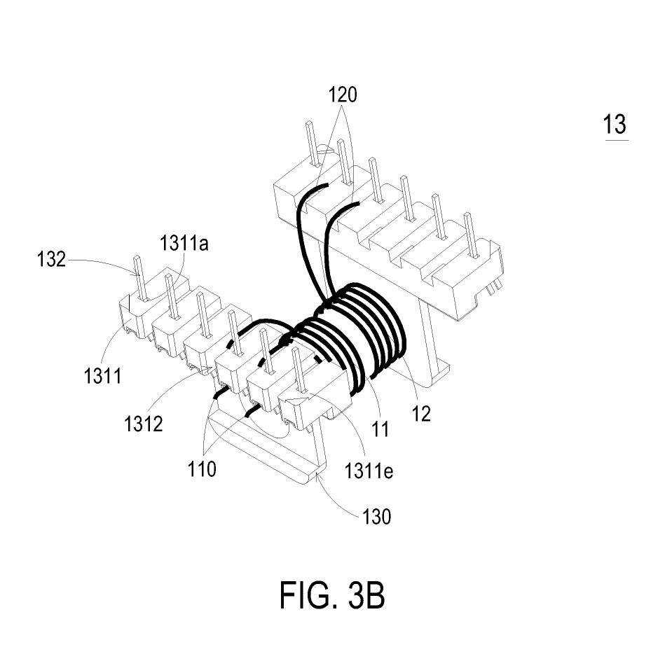

FIG. 3A is a schematic perspective view illustrating the bobbin, in which the primary winding coil and the secondary winding coil are wound around the bobbin. FIG. 3B is a schematic upside-down view of FIG. 3A. Please refer to FIGS. 2, 3A and 3B. The primary winding coil 11 and the secondary winding coil 12 are wound around the winding section 1301 of the main body 130. The outlet part 110 of the primary winding coil 11 or the outlet part 120 of the secondary winding coil 12 is moved from the bottom 1302 of the main body 130 along the surface of the first base 131, then pulled upwardly through the wire-arranging notch 1312 guided by the bulge 1311c, and then accommodated within the clamping part 1321 of the fastening pin 132.

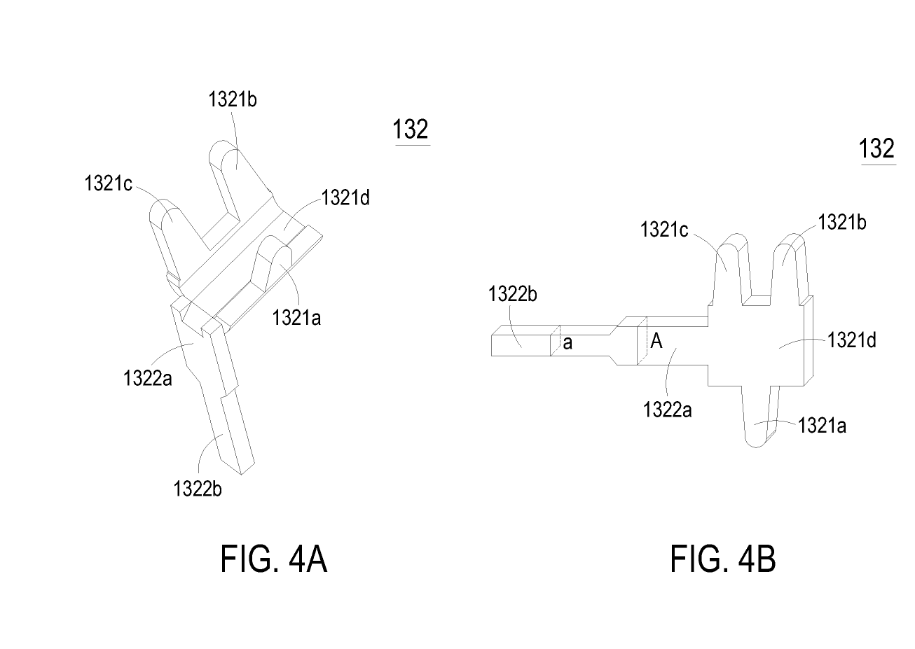

The clamping part 1321 includes a holder and one or more protrusions. In this embodiment, the clamping part 1321 includes a first protrusion 1321a, a second protrusion 1321b, a third protrusion 1321c and a holder 1321d. The first protrusion 1321a, the second protrusion 1321b and the third protrusion 1321c are arranged on bilateral sides of the holder 1321d in a staggered manner in order for clamping the outlet part 110 of the primary winding coil 11 or the outlet part 120 of the secondary winding coil 12. In some embodiments, the clamping part 1321 includes a holder and two protrusions (e.g. a first protrusion 1321a and a second protrusion 1321b), which are arranged on bilateral sides of the holder 1321d in a staggered manner. Moreover, the fastening pin 132 includes a conducting part 1322. The conducting part 1322 includes a first conducting segment 1322a and a second conducting segment 1322b (see FIG. 4A). The first conducting segment 1322a is connected with the holder 1321d. The second conducting segment 1322b is penetrated through the receiving recess 1311b and the perforation 1311a, received within the extension part 1311, and partially exposed to the lower surface 1311e of the extension part 1311. As such, the second conducting segment 1322b may be inserted into a contact portion (e.g. a conductive hole) of a circuit board. In the conducting part 1322 of the fastening pin 132, the cross-section area “A” of the first conducting segment 1322a is greater than the cross-section area “a” of the second conducting segment 1322b (see FIG. 4B). In addition, the capacity of the receiving recess 1311b is slightly greater than the volume of the holder 1321d of the clamping part 1321, so that the clamping part 1321 could be securely fixed in the receiving recess 1311b of the extension part 1311.

It is noted that, however, those skilled in the art will readily observe that numerous modifications and alterations may be made while retaining the teachings of the invention. For example, in some embodiments, the cross-section area “A” of the first conducting segment 1322a is equal to the cross-section area “a” of the second conducting segment 1322b. In this embodiment, the main body 130 of the bobbin 13 further includes a second base 133. The configurations and the winding approaches of the second base 133 are similar to those of the first base 131, and are not redundantly described herein. Whereas, the second base 133 is disposed under the bottom 1302 of the main body 130, and arranged at the opposite side of the first base 131 with respect to the main body 130. In some embodiment, the pins supported on the second base 133 are linear pins or L-shaped pins, which are known in the art.

Please refer to FIG. 1 again. The main body 130 of the bobbin 13 further includes a channel 1303. The magnetic core assembly 14 comprises a first magnetic core 141 and a second magnetic core 142. The middle portion 1410 of the first magnetic core 141 and the middle portion 1420 of the second magnetic core 142 are received within the channel 1303, and respectively arranged on two opposite sides of the bobbin 13. The middle portion 1410 of the first magnetic core 141 and the middle portion 1420 of the second magnetic core 142 may have cylindrical or rectangular shapes. In this embodiment, the first magnetic core 141 and the second magnetic core 142 are E cores, so that the magnetic core assembly 14 is an EE-type magnetic core assembly. Alternatively, the first magnetic core 141 and the second magnetic core 142 of the magnetic core assembly 14 may collectively define a UI-type magnetic core assembly or an EI-type magnetic core assembly.

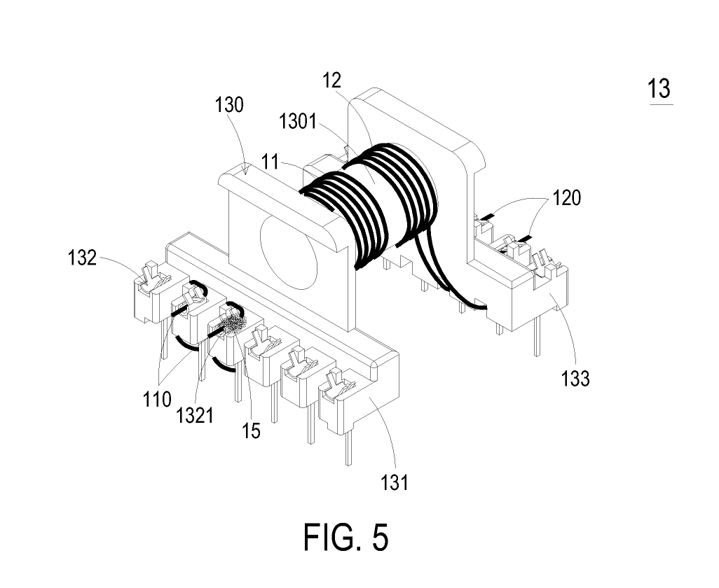

FIG. 5 is a schematic perspective view illustrating a portion of the bobbin of FIG. 3A, in which the outlet part of the winding coil clamped by the clamping part of the fastening pin. Please refer to FIGS. 3, 5A and 5. The outlet part 110 of the primary winding coil 11 or the outlet part 120 of the secondary winding coil 12 is moved from the bottom 1302 of the main body 130 along the surface of the first base 131, then pulled upwardly through the wire-arranging notch 1312 guided by the bulge 1311c, and then accommodated within the clamping part 1321 of the fastening pin 132. After the outlet part 110 of the primary winding coil 11 or the outlet part 120 of the secondary winding coil 12 is accommodated within the clamping part 1321 of the fastening pin 132, the first protrusion 1321a, the second protrusion 1321b and the third protrusion 1321c are bent toward the holder 1321d to clamp the outlet part 110 or 120 on the holder 1321d. In some embodiments, after the outlet part 110 or 120 are clamped on the holder 1321d, a solder paste 15 may be applied on the contact region between the clamping part 1321 and the outlet part 110 or 120, thereby securely fixing the outlet part 110 or 120 and reducing the wire-arranging time.

From the above description, the bobbin of the present invention has a fastening pin for clamping the outlet part of the winding coil. As such, the problem of causing a short-circuited problem or a large solder bump will be solved. In addition, since it is not necessary to wind the outlet part of the winding coil around the fastening pin, the possibility of deforming the pin is minimized and the wire-arranging time is reduced. Moreover, since the length and cross-section areas of the conducting parts of all fastening pins are identical, the conductive holes of the circuit boards could be elaborately controlled. In this situation, the problem of causing solder overflow or solder cavity will be overcome. On the other hand, since the welding gun is no longer contacted with the bobbin during the outlet part is soldered on the fastening pin, the problem of causing the molten bobbin or pin shift will be eliminated.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A transformer, comprising:
at least one primary winding coil;
at least one secondary winding coil;
a bobbin comprising a main body with at least one winding section, a first base disposed under said main body, and plural fastening pins disposed on said first base, wherein said primary winding coil and said secondary winding coil are wound around said main body, and each of said plural fastening pins comprises a clamping part for clamping an outlet part of said primary winding coil or said secondary winding coil on said first base; and
a magnetic core assembly partially received within said bobbin.

2. The transformer according to claim 1, wherein said first base of said bobbin comprises a connecting part and plural extension parts, wherein said connecting part is connected with said main body, and said plural extension parts are discretely arranged on a surface of said connecting part at regular intervals to define plural wire-arranging notches.

3. The transformer according to claim 2, wherein each extension part comprises a receiving recess and a bulge, wherein said clamping part of said fastening pin is accommodated within said receiving recess, and said bulge is arranged beside said receiving recess for guiding said outlet part of said primary winding coil or said secondary winding coil.

4. The transformer according to claim 3, wherein said outlet part of said primary winding coil or said secondary winding coil is moved through said wire-arranging notch of said first base, guided by said bulge, and then fixed by said clamping part of said fastening pin.

5. The transformer according to claim 1, wherein each fastening pin comprises a conducting part including a first conducting segment and a second conducting segment, wherein said first conducting segment is connected with said clamping part, and said second conducting segment is penetrated through a perforation of said extension part and partially exposed to a lower surface of said extension part.

6. The transformer according to claim 5, wherein in said conducting part of said fastening pin, the cross-section area of said first conducting segment is greater than that of said second conducting segment.

7. The transformer according to claim 1, wherein said clamping part of said fastening pin comprises plural protrusions and a holder, wherein said protrusions are arranged on bilateral sides of said holder in a staggered manner for clamping said outlet part of said primary winding coil or said secondary winding coil.

8. The transformer according to claim 1, wherein said bobbin further comprises a second base, which is disposed under said main body and arranged at an opposite side of said first base with respect to said main body, wherein said second base and said first base have the same configurations.

9. The transformer according to claim 1, wherein said main body comprises a channel, wherein said magnetic core assembly is partially received within said channel.

10. A bobbin, comprising:
a main body with at least one winding section, wherein at least one winding coil is wound around said winding section;
a base disposed under said main body; and
at least one fastening pin disposed on said base, and comprising a clamping part for clamping an outlet part of said winding coil on said base.
